(19) United States
(12) Patent Application Publication
(10) Pub. No.: US 2007/0288377 A1
(43) Pub. Date: Dec. 13, 2007

(54) SYSTEM AND METHOD FOR AUTHENTICATING A CUSTOMER'S IDENTITY AND COMPLETING A SECURE CREDIT CARD TRANSACTION WITHOUT THE USE OF A CREDIT CARD NUMBER

(76) Inventor: Yosef Shaked, Qiryat Ono (IL)

Correspondence Address: SUGHRUE MION, PLLC, 2100 PENNSYLVANIA AVENUE, N.W., SUITE 800, WASHINGTON, DC, 20037, US

(21) Appl. No.: 11/740,660

(22) Filed: Apr. 26, 2007

Related U.S. Application Data
(60) Provisional application No. 60/794,879, filed on Apr. 26, 2006.

(51) Int. Cl. G06Q 40/00

(52) U.S. Cl. 705/44; 235/380

(57) ABSTRACT

The present invention provides a system and method for authenticating a customer's identity and completing a credit card transaction between the customer and a merchant by authorizing a customer's transaction request without the use of the customer's credit card number or personal information. The method utilizes a customer's existing online account with a credit card issuer, which also eliminates the need for the customer to create and maintain a separate account with a third part service. Furthermore, the method can be easily implemented into the existing credit card authentication protocols, so that a merchant can implement the payment method quickly, easily, and at minimal cost

### PRIORITY CLAIM

This application claims the benefit of priority to U.S. Provisional Patent Application No. 60/794,879, filed Apr. 26, 2006, entitled “System and method for securing data information during online shopping without giving away credit card number.”

### BACKGROUND OF THE INVENTION

1. Field of the Invention

This invention relates to a method of secure electronic payments, and more specifically to a method for authenticating a customer's identity and making a credit card payment without submitting the credit card number and other personal information to a merchant.

2. Background

Online Internet commerce is a rapidly growing sector of the economy. The ease in which a customer can make purchases over the Internet using online merchants makes online shopping a fast-growing trend. However, one limitation to online shopping is that customers are almost always required to use their credit cards for purchasing goods or services over the Internet. While credit cards are a convenient form of payment, the use of credit cards on the Internet poses several risks, the primary one being credit card fraud and identity theft. Each time a customer uses a credit card, the credit card number and the customer's personal information must be provided to the merchant to verify the validity of the credit card. The personal information can include the customer's full name, residential address, and home phone number. If the merchant at the other end of the transaction is less than reputable, they have all of the information they need to use that customer's credit card for fraudulent purchases.

While customers obviously want to avoid having their credit card and personal information stolen, they have a difficult time determining if many online merchants are reputable. With countless numbers of small business selling products and services on the Internet, it is impossible to know if a website is reputable just by its look. When shopping online, many customers simply choose to avoid unknown websites that may be perfectly legitimate, merely because they are afraid of giving out their credit card number and personal information.

Attempts to solve this problem have been provided in the forms of third party accounts such as PayPal® or Google Checkout®, which allow a customer to set up an account and then purchase goods and services online using this account. These third party accounts store a customer's credit card information on file and process the credit card information themselves, while merchants then provide an additional payment option to customers for using the third party account when purchasing items on a merchant's site.

However, these services still have limitations. The first limitation is that customers must create accounts with these services and then memorize a username and password to use each time they want to use the payment method. Another limitation of services such as PayPal® is that the merchant must pay a fee to the service for providing customers with the alternative payment option. Finally, the main limitation is that customers must still provide their credit card information over the Internet along with their personal information, just to the third party service instead of the merchant. While the customer may trust the third party service, there is no guarantee that this information will be secure from viruses or computer hackers that often go after databases of credit card information maintained by merchants and payment services.

Therefore, what is needed is an electronic payment system that avoids the use or transmission of a customer's credit card information over the Internet, while still allowing the customer to purchase goods and services from a merchant using a credit card. Additionally, what is further needed is a simple, easy-to-use payment option for authenticating a customer and completing a secure online transaction without the hassle of creating and maintaining a separate account from a third party service. Finally, what is needed is a payment system that uses the existing credit card transaction and authentication protocols without requiring a separate, expensive system for merchants to install on their online stores.

### SUMMARY OF THE INVENTION

The present invention overcomes the aforementioned limitations and fills the aforementioned needs by providing a system and method for completing a credit card transaction between a customer and a merchant without requiring the customer to provide the credit card number or other personal information to the merchant. Additionally, the method utilizes a customer's existing Internet account with his or her trusted credit card issuer to authenticate the customer identity and authorize the transaction request, eliminating the need for the customer to create and maintain a separate account with a third party service. Furthermore, the method can be easily implemented into the existing credit card authentication protocols, so that a merchant can implement the payment method quickly, easily, and at minimal cost.

In one embodiment, the method for completing a credit card transaction comprises the acts of a customer selecting a good or service for purchase from a merchant; the customer selecting to pay with a credit card using alternate payment information that does not include the customer's credit card number; redirecting the customer to a system maintained by a credit card issuer, where the credit card issuer corresponds to the customer's credit card; authenticating the customer's identity with the issuer's system by logging into the issuer's system, such that the issuer generates an authentication code to send to the merchant to authenticate the customer's identity; transmitting the authentication code to the merchant; transmitting deal information for the credit card transaction from the merchant to the issuer, wherein the customer then reviews the deal information on the issuer's system; requesting the customer to accept or reject the credit card transaction after reviewing the deal information; generating an authorization code if the customer accepts the credit card transaction, or generating a rejection code if the customer rejects the credit card transaction; transmitting either the authorization code or rejection code to the merchant; wherein the merchant decides to complete the credit card transaction if an authorization code is received, or cancel the credit card transaction if a rejection code is received.

In another aspect, the act of completing the transaction further comprises the acts of settling the accounts between the merchant and the issuer so that the issuer pays the merchant for the good or service purchased by the customer.

In yet another aspect, the act of the merchant requesting alternative payment information further comprises the act of requesting the first six digits of the credit card number along with the credit card network.

In a further aspect of the present invention, the act of the merchant requesting alternative payment information further comprises the act of selecting a network from a list of potential networks.

In a further aspect of the present invention, the act of the customer selecting an issuer from a list of potential issuers.

In another aspect, a method of authenticating a customer's identity and completing a secure credit card transaction comprises the acts of providing a merchant with alternate payment information during a credit card transaction, wherein the alternate payment information does not include a customer's credit card number; forwarding the alternate payment information and deal information relating to the transaction to a service center to coordinate the transfer of the alternate payment information and deal information from the merchant to a credit card issuer that corresponds to the customer's credit card; directing the customer to a credit card issuer system, where the customer then enters his or her account information to access the issuer's system; such that when the customer accesses the system, the issuer authenticates the customer's identity to the merchant; and prompting the customer to confirm the deal information; wherein if the user confirms the deal information, the issuer authorizes the transaction to the merchant.

In a further aspect, a method for protecting the credit card information of a customer during a credit card transaction comprises the acts of selecting a credit card for use in a transaction between a customer and a merchant; transmitting alternate payment information from the customer to the merchant, wherein the alternate payment information does not contain a credit card number; transmitting deal information from the merchant to a credit card issuer that corresponds to the customer's credit card; requesting the customer to authorize the credit card transaction by logging into the credit card issuer's system and confirming the deal information using the issuer's system, wherein once the customer authorizes the transaction, an authorization code is generated; and transmitting the authorization code to the merchant to authorize the completion of the transaction.

In a further aspect of the present invention, the alternate payment information comprises the first several numbers of the credit card number that provide information on the credit card issuer and credit card network.

In another aspect of the present invention, a method for authenticating a customer's identity during a credit card transaction comprising the acts of: selecting a credit card for use in a transaction between a customer and a merchant; transmitting alternate payment information from the customer to the merchant, wherein the alternate payment information does not contain a credit card number; requesting the customer to authenticate his identity by logging into a credit card issuer's system, wherein upon successfully logging into the issuer's system, the issuer generates an authentication code; and transmitting the authentication code from the issuer to the merchant.

### BRIEF DESCRIPTION OF THE DRAWINGS

The invention is described herein with reference to particular embodiments thereof, which are exemplified in the drawings. It should be understood, however, that the various embodiments depicted in the drawings are only exemplary and may not limit the invention as defined in the appended claims.

FIG. 1 is a flow chart illustrating the process for authenticating a customer's identity and completing a credit card transaction between the customer and a merchant without the disclosure of the customer's credit card number or personal information, according to one embodiment of the present invention;

FIG. 2 is an image of a merchant's website with an option to choose a secure credit card payment system according to the present invention;

FIG. 3 is an image of a secure credit card payment system selection screen according to one embodiment of the present invention;

FIG. 4 is an image of a pending authentication screen on an issuer's website according to one embodiment of the present invention;

FIG. 5 is an image of a transaction confirmation screen on an issuer's website, according to one embodiment of the present invention;

FIG. 6 is an image of a transaction confirmation authentication screen on the merchant's website according to one embodiment of the present invention; and

FIG. 7 is a table depicting the process for clearing and settling charges between a merchant and an issuer.

### DETAILED DESCRIPTION OF THE INVENTION

The present invention provides a system and method for completing a credit card transaction between a customer and a merchant by authenticating a customer identity and authorizing a customer transaction without the use of the customer's credit card number or personal information. The merchant authenticates the customer identity by utilizing a customer's online account with an issuer's secure system, and the customer authorizes the credit card transaction using the issuer's secure system as well.

Glossary of Terms

To better understand the terms and definitions used throughout the specification and claims, please review the following glossary:

Customer: an authorized credit card user that is making a purchase with a credit card.

Issuer: a financial institution that issues credit cards and maintains a contract with a customer for repayment of the purchases made on the credit card.

Merchant: an authorized acceptor of credit cards for the payment of the goods and services sold by the merchant.

Acquirer: a business, usually a financial institution or merchant bank, that contracts with a merchant to coordinate credit card payments by customers with the network of the customer's credit card. The acquirer also provides clearing and settlement services to merchants.

Network: the mediator between the merchant's acquirer and the customer's issuer, such as Visa® or Mastercard®. The network primarily coordinates international credit card transactions between worldwide acquirers and worldwide issuers, and additionally coordinates clearing and settlement services to transfer payments from issuers to merchants.

Service Center: business that coordinates the processing of a secure credit card payment with the customer, issuer, merchant, acquirer, and network; without requiring a customer to provide a credit card number to a merchant.

In one embodiment of the present invention, the customer first initiates a payment to a merchant using a credit card by submitting alternate payment information, such as the first six digits of the customer's credit card number. Next, the merchant sends the alternative payment information to a service center, along with a list of acquirers and rules to determine the relevant acquirer. Then, the service center determines the relevant acquirer out of the list of acquirers and directs the alternate payment information to the selected acquirer. At this point, the selected acquirer directs the alternate payment information to a network that processes the information to determine the issuer of the customer's credit card. Next, the network forwards the alternate payment information and additional deal information related to the specific transaction to an issuer. Similarly to the process described above, the service center then directs the customer to the issuer's secure system, which could be a website or a proprietary interactive system available at a physical store. The customer then logs into the issuer's website, reviews the details of the transaction and authorizes the transaction with his or her issuer. The issuer then sends an authentication and authorization code to the service center through the same network mentioned previously. The service center thus finally passes the authentication code and authorization code to the merchant. The merchant then completes the transaction with the customer upon receipt of the issuer's authentication code, without ever having seen the customer's credit card information. The service center utilizes the existing credit card payment protocols available to a merchant, such as an acquirer, a network, and the issuer to request and receive the authentication from the issuer to complete the transaction.

One advantage of the system and method described herein is that customers no longer need to transmit their credit card information anywhere on the Internet, whether to a merchant or a third party payment service. Additionally, the customer does not need to set up an account with a separate payment service, as the present invention relies upon the account that a credit card issuer already has set up with its users. With the customer's credit card number and personal information only stored in one location, the issuer's secure system, there is much less of a risk of transmitting the credit card number to an unwanted or suspicious merchant. Additionally, the merchant has less risk of a purchase being deemed fraudulent and canceled, as the issuer is able to authenticate the customer for the merchant as well.

Furthermore, the customer no longer has to fill in lengthy or cumbersome forms with all of their personal information such as home address, billing address, and home phone number, as the issuer's website will verify this information and transmit only the sections necessary for completing the transaction to the merchant. For example, if a customer is purchasing something to be shipped to their home, the credit card issuer would transmit an authentication code along with the customer's pre-selected shipping address so the merchant can complete the transaction and mail the good to the customer without requiring the customer to enter the information again.

Authentication Process

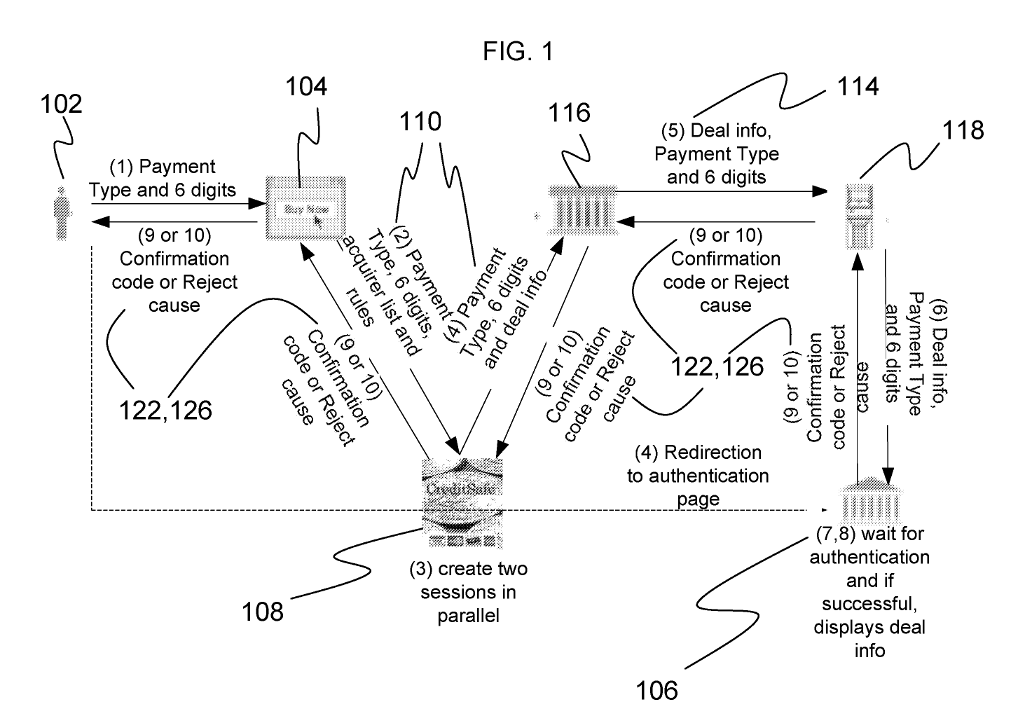

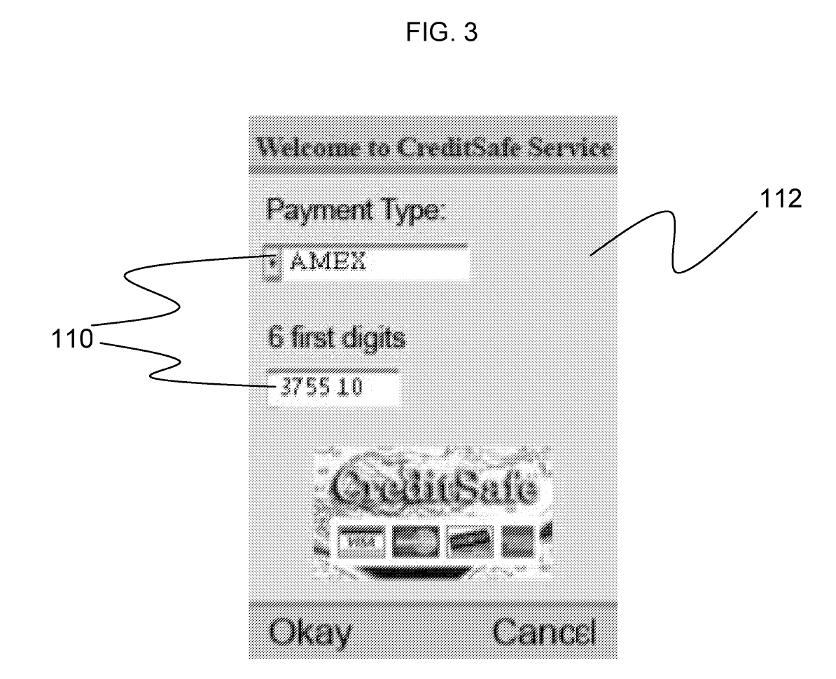

The authentication process provides additional detail as to how a credit card transaction is handled by the service center without requiring a customer to provide a merchant with his or her credit card number or other personal information. FIG. 1 provides a flow-chart depicting the actions taken by the customer 102, the merchant 104, and the issuer 106 as the service center 108 coordinates the transaction. First, a customer 102 browsing a merchant's web site 104 identifies an item to purchase and clicks a specific “buy” button which indicates that payment will be made without transmitting the customer's credit card number or other personal information to the merchant 104. The merchant 104 then prompts the customer 102 to enter alternate payment information 110. The goal of entering this alternate payment information 110 is to identify the issuer 106 of the customer's credit card, so that the service center 108 can direct the customer to the issuer's web site to be authenticated by the issuer. The alternate payment information 110 can include an option for selecting the credit card network, or “payment type,” such as Visa®, from a list of networks and then entering the first six digits of the customer's credit card information. The first six digits of a credit card identify the credit card issuer and network. FIG. 3 more clearly shows an image of a payment selection window 112 where a customer enters the alternate payment information 110. The alternate payment information 110 also includes deal information 114 on the transaction, such as the purchase price, merchant information, product information, and so on, which is eventually passed to the issuer 106 for authorizing the purchase with the customer 102.

In some embodiments, only four digits are needed to determine the issuer 106, but the use of six digits will provide more relevant results when searching for the issuer 106. In another embodiment, however, the customer could select from a different set of menus that would narrow down the potential list of issuers and help the customer more quickly find the issuer's website needed for authentication. For example, one menu could list the country where the customer lives, and the second menu would then list the issuers within that country, thereby shortening the process for a customer to identify the issuer and more quickly complete the transaction. Many customers typically shop within their own country, so a location-based menu system can automatically narrow down the options to first include only issuers within a certain geographic or national proximity to the customer. In a menu system such as this, the customer would not need to enter the first six digits of his or her credit card, as the menus will determine the same information conveyed by the first six digits.

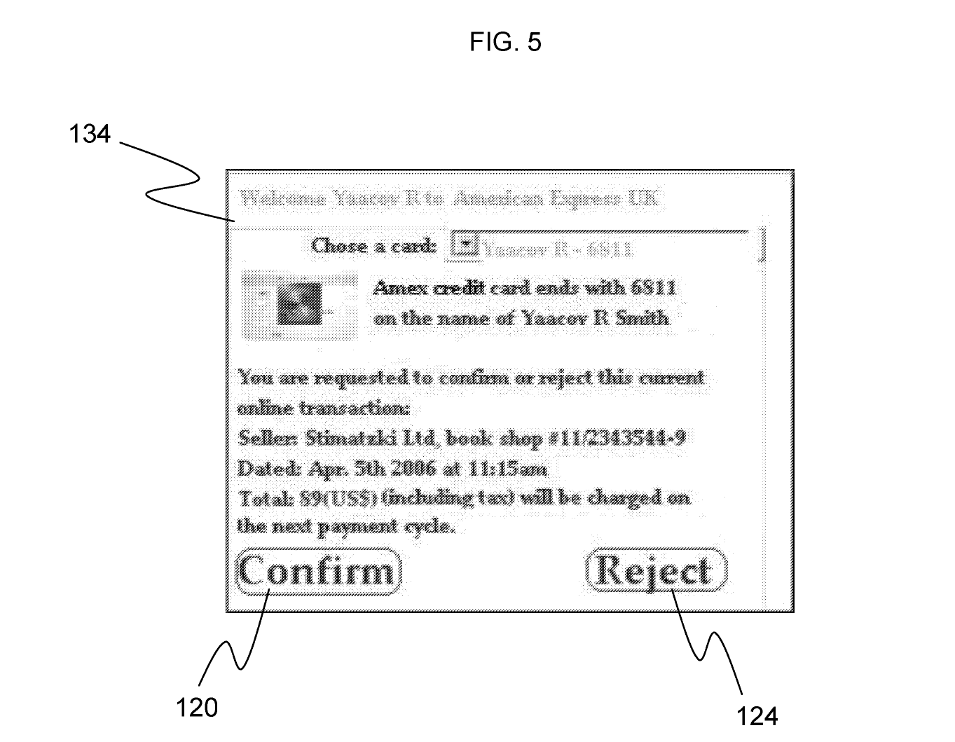

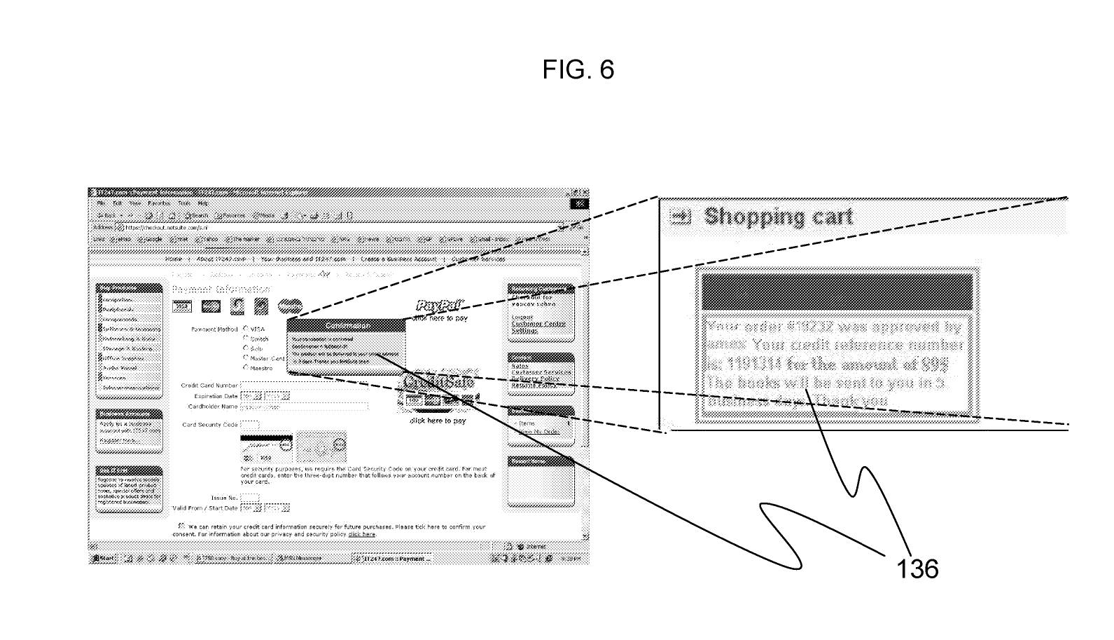

Once the customer 102 enters the alternate payment information 110, it is passed to the service center 108, which forwards it to an acquirer 116. The acquirer 116 selects the appropriate network 116, and the network 116 then forwards the deal information 114 to the issuer 106. The deal information 114 is then presented to the customer 102 once the customer 102 logs in to the issuer's website or issuer's service application. If the customer 110 accepts the transaction and clicks “confirm” 120 (see FIG. 5), the issuer 106 generates an authentication code and an authorization code 122. At this point, the customer's identity 102 has been authenticated by the issuer 106 and can properly transmit the deal information 114, authentication code, and authorization code back to the merchant 104 to complete the transaction. The authentication code and authorization code 122, along with other needed personal information related to the customer 102—e.g. home address, shipping address, full name-is then passed back through the network 118, to the acquirer 116, to the service center 108, and finally back to the merchant's website, where the merchant 104 and customer 102 see a confirmation screen 108, as depicted in FIG. 6.

The customer 102 has the option to cancel the transaction with the merchant 104 at the issuer's website or issuer's service application by clicking on the “reject” button 124, as seen in FIG. 5. If the transaction is rejected, then the issuer 106 generates a rejection code 126, which is transmitted to the merchant 104 to indicate that the transaction has been rejected. The customer would then see a rejection screen instead of the confirmation screen 108 of FIG. 6.

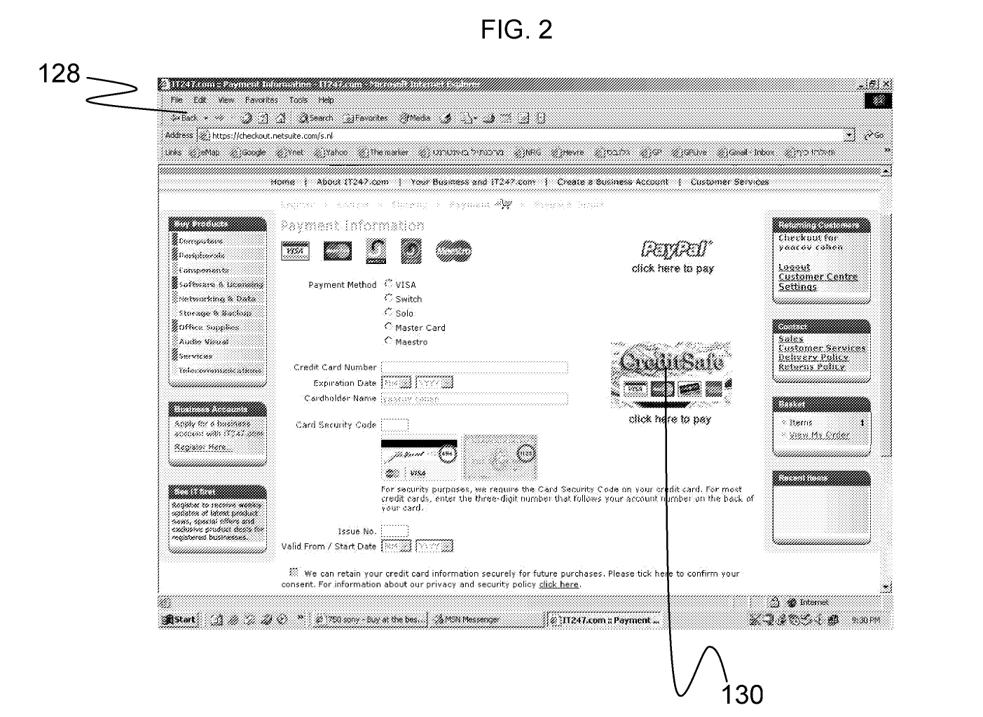

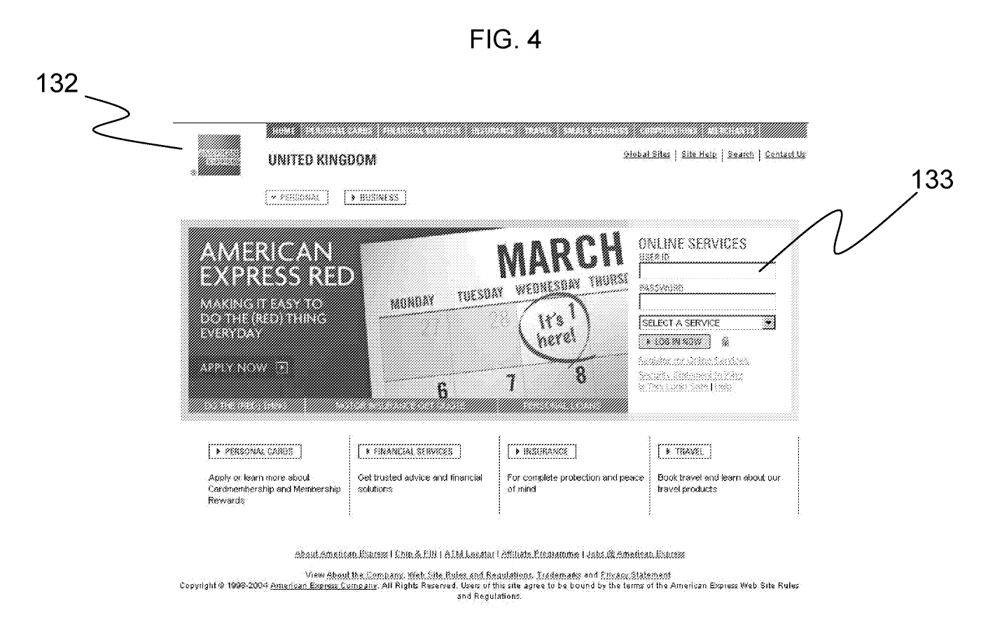

A customer using the secure credit card payment system of the present invention would typically view five different web pages during the transaction process. FIG. 2 depicts the first page of the secure credit card payment system, an image of a merchant's website 128 with a window 130 to choose the secure credit card payment system. Once the customer clicks on this window, the payment selection window 112 appears, as shown in FIG. 3. After the customer enters the alternate payment information 110, the service center directs the customer's browser to the issuer's web page 132, as shown in FIG. 4. Here, the customer enters his or her existing username and password in the appropriate field 133 in order to access the credit card account and provide authentication of his or her identity to the issuer. This username and password is typically the same one used to check the credit card balance online or schedule an online payment. Once the customer 102 is logged in, his or her identity has been authenticated by the issuer 106, which results in an authentication code being generated by the issuer 106 and transmitted back to the merchant 104. Once logged in, the customer will be directed to the transaction authorization screen 134, as depicted in FIG. 5. The transaction authorization screen 134 displays the deal information 114 for the customer to review before authorizing the transaction. The customer then chooses to either confirm 120 the transaction or reject 124 the transaction. Depending on the customer's selection, either an authorization code 122 (see FIG. 1) or a rejection code 126 (see FIG. 1) is generated by the issuer. The customer is then redirected back to the merchant's website 128, as shown in FIG. 6, where it will display a new confirmation window 136 indicating whether the transaction was authorized or rejected.

It is important to note that portions of the process described above happen in an underlying protocol that is not noticeable to the customer. For example, once the customer enters the six digits of the credit card number and the payment type, the next computer screen will be the issuer's website requesting a login and password. In the meantime, the process of forwarding this information from the merchant to the service center, then to the acquirer, then to the network, and then to the issuer is not known or realized by the customer.

The aforementioned process assumes that the customer has an account with the issuer's website which can be utilized for the authentication process. However, if the customer does not have an online account, there are still options available. First, the customer can create an account on the spot. Second, the customer could merely enter the credit card number and security code into the issuer's website, perhaps answer a few pre-determined questions, and verify their identity and authorize the transaction for a single use. In one embodiment, customers without an account that are entering their credit card information on each transaction would be prohibited from changing their shipping or billing address as an added security feature.

Although the previous embodiment is described in relation to an Internet transaction, the system described above could also be implemented for a physical transaction in a store as well. A merchant could implement a system at an Internet-enabled cash register whereby the customer who wishes to make a credit card purchase uses their credit card only to identify their issuer and direct the cash register to the issuer's website. Or, as discussed previously, the use of any part of the credit card number could be avoided entirely with a series of menu selections where the customer identifies his or her credit card issuer and network. In either method, the customer is directed to the issuer's site, where the customer will enter their account information to be authenticated by the issuer, then review and authorize the purchase as described above. The merchant will receive the authentication code and authorization code and complete the transaction with the customer. Again, the customer does not have to provide their full credit card information to the merchant, thus providing additional security and peace of mind to the customer.

Clearing and Settlement Process

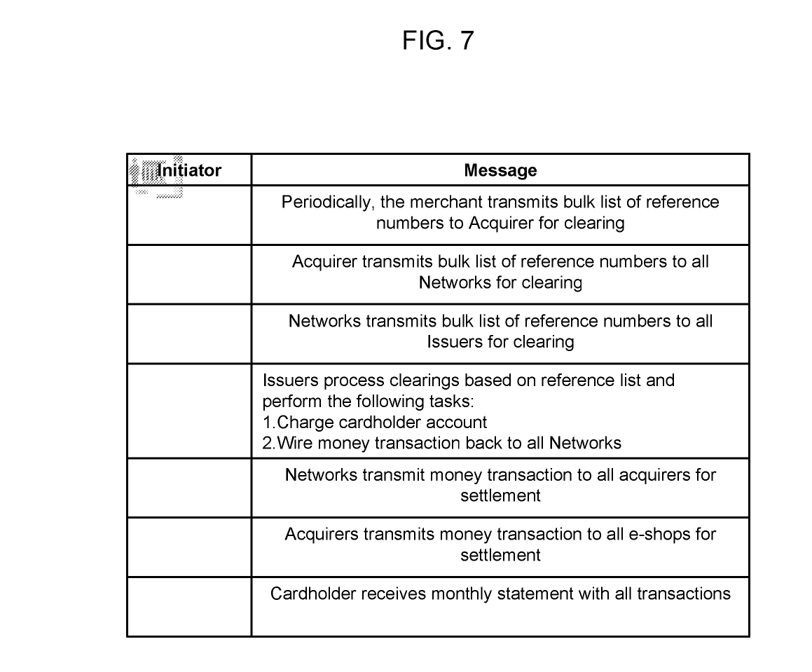

Once the transaction between the customer and merchant has been authenticated, the merchant must still “clear,” or “settle” the charge with the issuer. A table depicting the clearing and settlement process is depicted in FIG. 7. In one embodiment of the clearing or settlement process, the merchant transmits and deposits the authorized transactions, in the form of the authorization numbers, with the acquirer. The acquirer then transmits the transactions through the network, after which the network credits the acquirer and debits the issuer. Finally, the issuer posts the transaction to the customer account and places it into the normal billing cycle for appearance on the next month's bill.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the plasma chamber arts. It is intended that the specification and examples be considered as exemplary only, with a true scope and spirit of the invention being indicated by the following claims.

What is claimed is:

1. A method for completing a credit card transaction comprising the acts of:
a customer selecting a good or service for purchase from a merchant;
the customer selecting to pay with a credit card using alternate payment information that does not include the customer's credit card number;
redirecting the customer to a system maintained by a credit card issuer, where the credit card issuer corresponds to the customer's credit card;
authenticating the customer's identity with the issuer's system by logging into the issuer's system, such that the issuer generates an authentication code to send to the merchant to authenticate the customer's identity;
transmitting the authentication code to the merchant;
transmitting deal information for the credit card transaction from the merchant to the issuer, wherein the customer then reviews the deal information on the issuer's system;
requesting the customer to accept or reject the credit card transaction after reviewing the deal information;
generating an authorization code if the customer accepts the credit card transaction, or generating a rejection code if the customer rejects the credit card transaction;
transmitting either the authorization code or rejection code to the merchant; wherein the merchant decides to complete the credit card transaction if an authorization code is received, or cancel the credit card transaction if a rejection code is received.

2. The method of claim 1, wherein the act of completing the transaction further comprises the acts of settling the accounts between the merchant and the issuer so that the issuer pays the merchant for the good or service purchased by the customer.

3. The method of claim 1, wherein the act of the merchant requesting alternative payment information further comprises the act of requesting the first six digits of the credit card number along with the credit card network.

4. The method of claim 1, wherein the act of the merchant requesting alternative payment information further comprises the act of selecting a network from a list of potential networks.

5. The method of claim 1, further comprising the act of the customer selecting an issuer from a list of potential issuers.

6. A method of authenticating a customer's identity and completing a secure credit card transaction comprising the acts of:
providing a merchant with alternate payment information during a credit card transaction, wherein the alternate payment information does not include a customer's credit card number;
forwarding the alternate payment information and deal information relating to the transaction to a service center to coordinate the transfer of the alternate payment information and deal information from the merchant to a credit card issuer that corresponds to the customer's credit card;
directing the customer to a credit card issuer system, where the customer then enters his or her account information to access the issuer's system; such that when the customer accesses the system, the issuer authenticates the customer's identity to the merchant; and
prompting the customer to confirm the deal information; wherein if the user confirms the deal information, the issuer authorizes the transaction to the merchant.

7. A method for protecting the credit card information of a customer during a credit card transaction comprising the acts of:
selecting a credit card for use in a transaction between a customer and a merchant;
transmitting alternate payment information from the customer to the merchant, wherein the alternate payment information does not contain a credit card number;
transmitting deal information from the merchant to a credit card issuer that corresponds to the customer's credit card;
requesting the customer to authorize the credit card transaction by logging into the credit card issuer's system and confirming the deal information using the issuer's system, wherein once the customer authorizes the transaction, an authorization code is generated; and
transmitting the authorization code to the merchant to authorize the completion of the transaction.

8. The method of claim 7, wherein the alternate payment information comprises the first several numbers of the credit card number that provide information on the credit card issuer and credit card network.

9. The method of claim 7, wherein the alternative payment information further comprises the act of selecting a network from a list of potential networks.

10. The method of claim 7, further comprising the act of the customer selecting a credit card issuer from a list of potential issuers.

11. A method for authenticating a customer's identity during a credit card transaction comprising the acts of:
selecting a credit card for use in a transaction between a customer and a merchant;
transmitting alternate payment information from the customer to the merchant, wherein the alternate payment information does not contain a credit card number;
requesting the customer to authenticate his identity by logging into a credit card issuer's system, wherein upon successfully logging into the issuer's system, the issuer generates an authentication code; and
transmitting the authentication code from the issuer to the merchant.

12. The method of claim 11, wherein the alternate payment information comprises the first several numbers of the credit card number that provide information on the credit card issuer and credit card network.

13. The method of claim 11, wherein the act of the merchant requesting alternative payment information further comprises the act of selecting a network from a list of potential networks.

14. The method of claim 11, further comprising the act of the customer selecting the credit card issuer from a list of potential issuers.
